(19) United States
(12) Patent Application Publication
(10) Pub. No.: US 2003/0075102 A1
(43) Pub. Date: Apr. 24, 2003

(54) System for inverting substrates

(76) Inventor: Ronald A. Crocker, Hanover, MA (US)

Correspondence Address: DEVINE, MILLIMET & BRANCH, P.A., 111 AMHERST STREET, BOX 719, MANCHESTER, NH, 03105, US

(21) Appl. No.: 10/279,145

(22) Filed: Oct. 23, 2002

Related U.S. Application Data
(60) Provisional application No. 60/343,647, filed on Oct. 24, 2001.

(51) Int. Cl. B05C 13/00

(52) U.S. Cl. 118/50; 118/500

(57) ABSTRACT

The present invention is a substrate inverting apparatus mounted to a substrate-coating machine. The apparatus is used for inverting a substrate within a vacuum chamber. The apparatus includes a substrate holding means for holding the substrate substantially rigidly relative to the substrate holding means. The apparatus further includes an actuating means mounted to the substrate-coating machine for inverting the substrate holding means.

The present application claims priority, based on provisional application serial No. 60/343,647, filed Oct. 24, 2001.

### FIELD OF THE INVENTION

The present invention is in the field of substrate coating machinery. More specifically, the present invention is directed toward substrate holders in substrate coating machinery.

### BACKGROUND OF THE INVENTION

Presently, there are many applications substrates with film deposited on two sides known in the art. The standard method for applying film to a substrate involves mounting the substrate within a vacuum chamber, evacuating the chamber and mechanically spraying the film onto the substrate. The chamber is then repressurized, the substrate is inverted to its other side, the chamber is again evacuated and the film is sprayed onto the other side of the substrate. Because evacuating and depressurizing a chamber is time-consuming, depositing film on two sides of a substrate is very time-consuming.

To decrease the time required for this process, individuals have thought to develop mechanical devices for inverting the substrate. The difficulty in inverting the substrate is caused by the fact that the substrate holder is within the vacuum chamber and continuously rotating in many substrate-coating machines. The rotation may be isolated or combined in a planetary rotational system and may be rational or irrational. The rotation of the substrate allows the film to be deposited evenly across the substrate. However, the rotation also makes it difficult to invert the substrate from the machinery.

Some mechanical devices developed to invert the substrate have been in the form of a cam, ramp or other actuator mounted on the floor of the vacuum chamber. The actuator mechanically moves to invert the substrate holder as the substrate holder rotates. However, the rotation of the substrate is difficult to time and predict resulting, on some occasions, in missed efforts and partial inversions from the actuator. On other occasions, the substrate holder will solidly strike the cam, causing the substrate holder to rotate too quickly, jarring the substrate loose and otherwise damaging the substrate holder. This type of actuator is also only capable of inverting the substrate holder once, which may also limit the usefulness of inverting the substrate and is only capable of inverting the substrate 180 degrees. Finally, this device requires permanently mounting the actuator to the vacuum chamber, impinging on the value and future use of the vacuum chamber.

### SUMMARY OF THE INVENTION

The present invention results from the realization that a controllable inverting actuator mounted on the substrate coating machine instead of the vacuum chamber floor increases the reliability of the inverting mechanism, allows both sides of the substrate to receive film deposits, and allows the substrate to be inverted on a plurality of occasions while mounted on a substrate holder rotating rationally or irrationally.

It is therefore an object of the invention to invert the substrate for depositing film on both sides of the substrate.

Furthermore, it is an object of the invention in at least one embodiment that the substrate is inverted while the substrate holder is continuously rotating in a singly or planetary rotational system, rationally or irrationally.

Furthermore, it is an object of the invention in at least one embodiment that the substrate be inverted completely and reliably whenever inverting is desired and to precise angles varying from 0-180 degrees, which is particularly helpful when coating prisms or other angular substrates.

Furthermore, it is an object of the invention in at least one embodiment to control the speed by which the substrate is inverted to avoid jarring the substrate loose or otherwise damage the substrate holder.

### BRIEF DESCRIPTION OF THE INVENTION

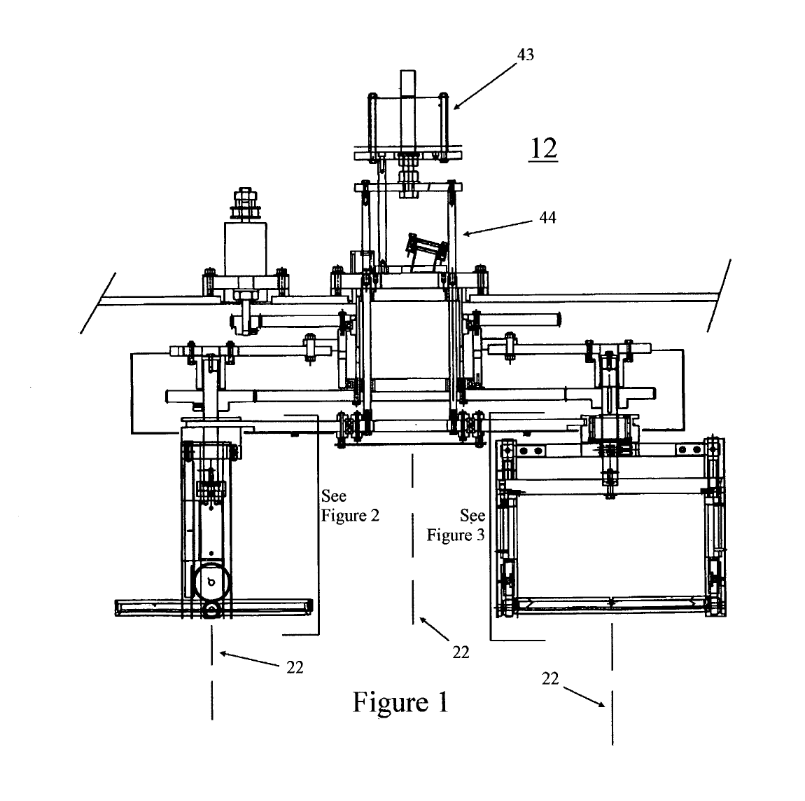

FIG. 1 shows a schematic of one embodiment of the present invention on a substrate coating machine with two substrate holders shown at 90-degree angles, respectively.

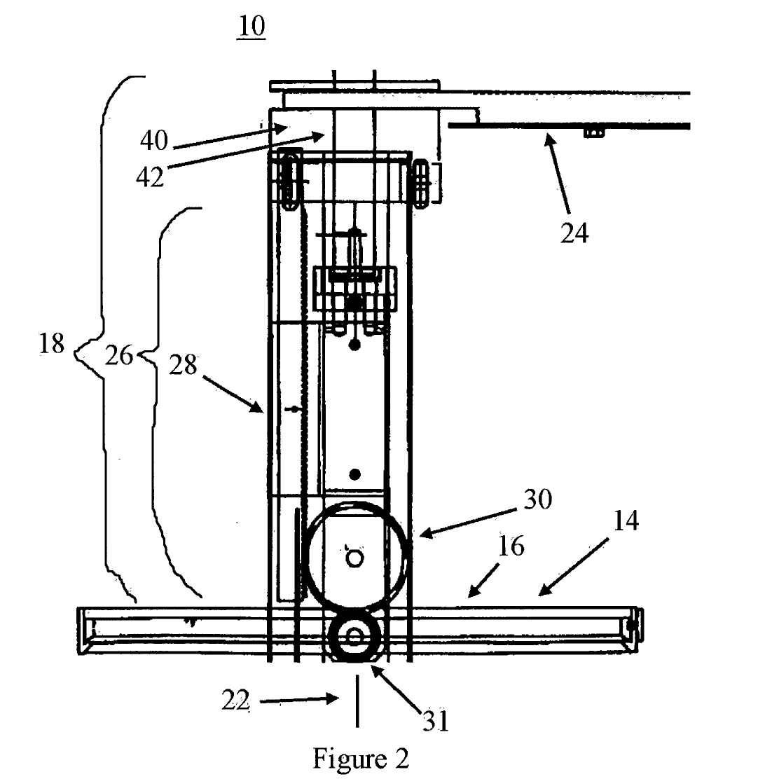

FIG. 2 shows a schematic of one embodiment of the present invention, specifically encompassing one of the substrate holders shown in FIG. 1.

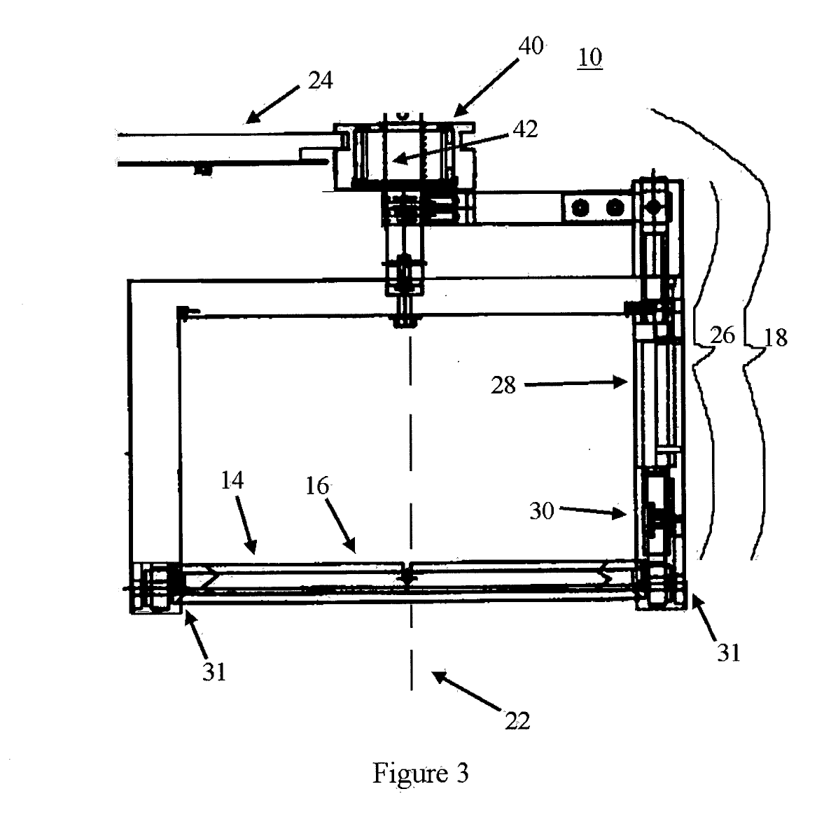

FIG. 3 shows a schematic of one embodiment of the present invention, specifically encompassing one of the substrate holders shown in FIG. 1.

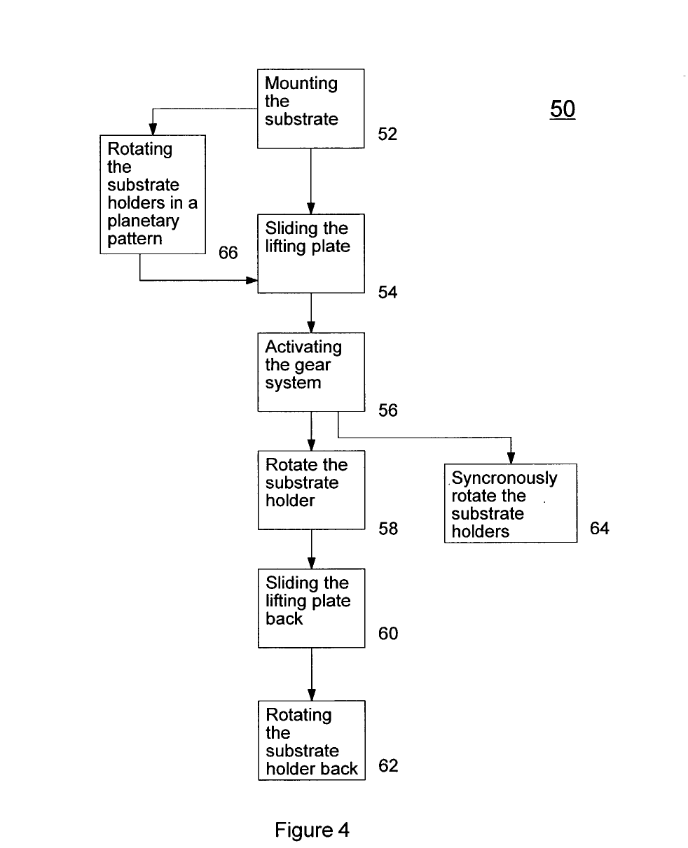

FIG. 4 shows a flow diagram of one embodiment of the present invention.

### DETAILED DESCRIPTION OF THE INVENTION

The present invention is a substrate inverting apparatus 10 mounted to a substrate-coating machine 12, as shown in FIG. 1. The apparatus 10 is used for inverting a substrate 14 within a vacuum chamber. The apparatus 10 includes a substrate holding means 16 for holding the substrate 14 substantially rigidly relative to the substrate holding means 16. The apparatus 10 further includes an actuating means 18 mounted to the substrate-coating machine 12 for inverting the substrate holding means 16.

A narrower embodiment of the substrate inverting apparatus 10 involves a plurality of substantially-vertical axes 22 about which the substrate holding means 16 is rotated in a planetary pattern.

The substrate inverting apparatus 10 further includes a plurality of substrate holding means 16 wherein the actuating means 18 inverts the plurality of substrate holding means 16 whereby multiple substrates 14 may be coated simultaneously.

The actuating means 18, in one embodiment, includes a slidable lifting plate 24 and a gear system 26. The slidable lifting plate 24 mounts to the substrate-coating machine 12. The gear system 26 mounts between the lifting plate 24 and the substrate holding means 16 thereby synchronously inverting the plurality of substrate holding means 16 when the lifting plate 24 slides. In the embodiment shown in FIG. 2, the lifting plate 24 moves vertically to rotate the substrate holding means 16, although one skilled in the art would be able to fashion a similar apparatus 10 in which the lifting plate 24 moves horizontally and/or axially to accomplish the same objective.

The actuating means 18 includes an external actuator 43, as shown in the FIG. 1 embodiment, for initiating the sliding of the lifting plate 24. The external actuator 43 is located outside of the vacuum chamber and connects to the lifting plate 24 with connecting rods 44. The external actuator 43 controls the vertical motion of the lifting plate 24 through the connecting rods 44.

The gear system 26 can be further embodied by at least one rack 28 and pinion 30 mechanism for each substrate holding means 16. One embodiment of the present invention with two substrate holding means 16 is depicted in FIG. 1. The gear system 26 on one of the substrate holding means 16 depicted contains two rack 28 and pinion 30 mechanisms, on opposite sides of the substrate holding means 16. Alternatively, as in FIG. 3, only one rack 28 and pinion 30 mechanism is required. Ideally, pivotable joints 31 are on opposing sides of the substrate holding means 16. If only one rack 28 and pinion 30 mechanism is used, the rack 28 and pinion 30 mechanism is connected to one of the pivotable joints 31, which applies an undesirable force and wear on the opposite pivotable joint 31. Therefore, in a preferred embodiment, two rack 28 and pinion 30 mechanisms are used per substrate holding means 16, one mechanism for each pivotable joint 31.

Finally, another narrow embodiment of the apparatus involves a bearing/bushing holder 40 connecting the lifting plate 24 to the gear system 26. The bearing/bushing holder 40 can contain a bushing, but the preferred embodiment involves the bearing/bushing holder 40 containing at least one linear bearing 42.

The inverting apparatus 10 is activated when the lifting plate 24 is vertically shifted. In the embodiment shown in FIG. 1, the lifting plate 24 is vertically shifted using the externally mounted actuator 43 and connecting rods 44. Shifting the lifting plate 24 shifts the rack 28. When rack 28 shifts, the pinion 30 is rotated. Rotating the pinion 30 rotates the substrate holding means 16. The actuator means 18 can be preset to rotate the substrate holding means 16 one hundred eighty degrees or any other preferred angle. The depicted embodiment is further designed so that returning the lifting plate 24 back to its original position shifts the rack 28, rotates the pinion 30, and rotates the substrate holding means 16 to its original position.

The inventive substrate inverting apparatus 10 can also be provided as a retrofitting kit for mounting the apparatus 10 to a substrate-coating machine 12. The kit includes a substrate holding means 16, a gear system 26 and a lifting plate 24 or other actuating means 18. The gear system 26 is mateable to the substrate holding means 16. The assembled kit operates substantially identically to the herein described substrate inverting apparatus 10.

The present invention is also a method 50 for inverting a substrate held on a substrate-coating machine. The method involves mounting 52 the substrate to a substrate holder and sliding 54 a lifting plate from an original position on the substrate-coating machine, said sliding 54 activating 56 a gear system on the substrate-coating machine which rotates 58 the substrate holder on a horizontal axis in a forward motion.

A narrower embodiment of the inventive method 50 occurs wherein the substrate holder rotates 58 less than one hundred-eighty degrees. Another narrower embodiment of the inventive method 50 further involves sliding 60 the lifting plate back to the original position which rotates 62 the substrate holder opposite the forward motion. Another narrower embodiment of the inventive method occurs wherein the gear system is a pair of rack and pinion gears connected between the substrate holder and the lifting plate, wherein the gears are connected to the lifting plate with a bearing holder containing at least one linear bearing. Another narrower embodiment involves using a plurality of substrate holders, wherein activating 56 the gear system synchronously rotates 64 the plurality of substrate holders. Preferably, the inventive method 50 involves rotating 66 the substrate holders in a planetary pattern. The planetary system works to provide a consistent film deposition on all of the substrates.

Although the present invention has been described in terms of specific exemplary embodiments, it will be appreciated that various modifications and alterations might be made by those skilled in the art without departing from the spirit and scope of the invention as set forth in the following claims.

We claim:

1. A substrate inverting apparatus, mounted to a substrate coating machine, for inverting a substrate within a vacuum chamber, said apparatus comprising:
a substrate holding means for holding the substrate substantially rigidly relative to the substrate holding means; and
an actuating means mounted to the substrate coating machine for inverting the substrate holding means.

2. The substrate inverting apparatus of claim 1 further comprising a plurality of substantially-vertical axes about which the substrate holding means is rotated in a planetary pattern.

3. The substrate inverting apparatus of claim 2 further comprising a plurality of substrate holding means wherein the actuating means is for inverting the plurality of substrate holding means whereby multiple substrates may be coated simultaneously.

4. The substrate inverting apparatus of claim 3 wherein the actuating means further comprises:
a slidable lifting plate mounted to the substrate coating machine;
an external actuator connected to the lifting plate; and
a gear system mounted between the lifting plate and the plurality of substrate holding means thereby synchronously inverting the substrate holding means when the lifting plate slides.

5. The substrate inverting apparatus of claim 4 wherein the gear system is at least one rack and pinion mechanism for each of the plurality of substrate holding means.

6. The substrate inverting apparatus of claim 5 wherein the gear system is two rack and pinion mechanisms on opposing sides of the substrate holding means.

7. The substrate inverting apparatus of claim 4 wherein the lifting plate is secured to the gear system by a bearing holder containing at least one linear bearing.

8. A substrate inverting apparatus kit for retrofitting a substrate inverting apparatus to a substrate coating machine to invert a substrate within a vacuum chamber, said kit comprising:
a substrate holding means;
a gear system mateable to the substrate holding means; and
an actuating means, mountable to a substrate coating machine, for actuating the gear system.

9. The substrate flipping apparatus of claim 8 wherein the actuating means is a lifting plate controlled by an external actuator.

10. A method for inverting a substrate held on a substrate-coating machine within a vacuum chamber, said method comprising:
mounting the substrate to a substrate holder; and
sliding a lifting plate from an original position on the substrate-coating machine, said sliding activating a gear system on the substrate-coating machine which rotates the substrate holder on a horizontal axis in a forward motion.

11. The method of claim 10 wherein the substrate holder is rotated less than one hundred-eighty degrees.

12. The method of claim 10 further comprising sliding the lifting plate back to the original position which rotates the substrate holder opposite the forward motion.

13. The method of claim 10 wherein the gear system is a pair of rack and pinion gears connected between the substrate holder and the lifting plate, wherein the gears are connected to the lifting plate with a bearing holder containing at least one linear bearing.

14. The method of claim 10 wherein activating a gear system on the substrate-coating machine synchronously rotates a plurality of substrate holders on a horizontal axis in a forward motion.

15. The method of claim 14 further comprising rotating each of the plurality of substrate holders on a plurality of vertical axes thereby moving in a planetary pattern.
